(19) United States
(12) Patent Application Publication
(10) Pub. No.: US 2024/0060419 A1
(43) Pub. Date: Feb. 22, 2024

(54) METHOD AND SYSTEM FOR AUTOMATED ROCK RECOGNITION

(71) Applicant: TECHNOLOGICAL RESOURCES PTY. LIMITED, Melbourne (AU)

(72) Inventors: Francisco RODRIGUEZ, Salt Lake City, UT (US); Bhupendra KUMAR, Melbourne (AU); Saskia DUYVESTEYN, Salt Lake City, UT (US)

(21) Appl. No.: 18/268,207

(22) PCT Filed: Dec. 17, 2021
(86) PCT No.: PCT/AU2021/051512

§ 371 Date: Jun. 16, 2023

(30) Foreign Application Priority Data
Dec. 17, 2020 (AU) 2020904710
Dec. 24, 2020 (AU) 2020904850

(51) Int. Cl. E21C 39/00; E21B 49/00

(52) U.S. Cl. CPC E21C 39/00; E21B 49/00; E21B 2200/20; E21C 2100/00

(57) ABSTRACT

Methods and systems for rock recognition are provided. In one embodiment, a method comprises: receiving or generating, at one or more computing systems, data comprising at least one drilling variable for a plurality of drilled holes across observations at a plurality of depths, wherein the at least one drilling variable is a variable affected by at least one physical characteristic of rock in the plurality of drilled holes; determining, by the one or more computing systems, a plurality of characteristic measures for each of the plurality of drilled holes, wherein the plurality of characteristic measures for each drilled hole comprise: at least one characteristic measure of a first type, wherein a characteristic measure of the first type is a measure based on a comparison of a distribution of a said at least one drilling variable for the drill hole with a distribution of a related or the same drilling variable across a plurality of the drilled holes; and at least one characteristic measure of a second type, wherein a characteristic measure of the second type is based on said at least one drilling variable across the plurality of depths of the drilled hole; applying, by the one or more computing systems, unsupervised learning to the plurality of characteristic measures, the unsupervised learning determining groups of the drilled holes; and generating, by the one or more computing systems, an output indicating the determined groups of the drilled holes.

### RELATED APPLICATIONS

This application is related to Australian Provisional Application No. 2020904710 filed on 17 Dec. 2020 and Australian Provisional Application No. 2020904850 filed on 24 Dec. 2020, the contents of which are incorporated herein by reference.

### FIELD

The disclosure relates to the field of rock recognition. The disclosed embodiments of methods and systems for rock recognition are applicable in the mining industry and may particularly find use in automated mining environments.

### BACKGROUND

Mining operations require information on the distribution and properties of various types of rock in the subsurface. For example, knowledge of the subsurface distribution and properties of mineral or metal bearing rock can be particularly useful for achieving effective mining operations.

Accordingly, sensors and related technologies for sensing and identifying the distribution of mineral or metal bearing rock and/or the distribution of other rock types, form an important aspect of mining operations. These technologies form an estimate of rock hardness distribution, based on measurement samples taken from the mine site. The estimated rock hardness distribution can then be used to determine or control subsequent operations. For example, rock hardness distribution can affect blasting, and extracting of the rock at the mine site and can affect crushing, grinding, sorting, concentrating and/or beneficiation processes of the rock. Extracted rock may also be transported based on the estimated rock hardness distribution, for example from the mine site or from one processing stage or site, to another particular processing site or particular input or stock pile for a processing site. There is a continuing need for techniques for forming useful estimates.

### SUMMARY

According to an embodiment of the present disclosure, there is provided a method, comprising:
receiving or generating, at one or more computing systems, data comprising at least one drilling variable for a plurality of drilled holes across observations at a plurality of depths, wherein the at least one drilling variable is a variable affected by at least one physical characteristic of rock in the plurality of drilled holes;
determining, by the one or more computing systems, a plurality of characteristic measures for each of the plurality of drilled holes, wherein the plurality of characteristic measures for each drilled hole comprise:
   at least one characteristic measure of a first type, wherein a characteristic measure of the first type is a measure based on a comparison of a distribution of a said at least one drilling variable for the drill hole with a distribution of a related or the same drilling variable across a plurality of the drilled holes; and
   at least one characteristic measure of a second type, wherein a characteristic measure of the second type is based on said at least one drilling variable across the plurality of depths of the drilled hole;
applying, by the one or more computing systems, unsupervised learning to the plurality of characteristic measures, the unsupervised learning determining groups of the drilled holes; and
generating, by the one or more computing systems, an output indicating the determined groups of the drilled holes.

In some embodiments, the at least one drilling variable for a plurality of drilled holes across a plurality of depths may comprise a measure of mechanical specific energy (MSE). The at least one measure of the first type and/or the second type may be based on MSE.

In some embodiments, the distribution of a related or the same drilling variable across a plurality of the drilled holes may be divided into a plurality of groups and the at least one measure of the first type may be a proportion of said observations of a drill hole that are within each group. The plurality of groups may be based on variations from a mean of the drilling variable across the plurality of drilled holes.

In some embodiments, the at least one measure of a second type may comprise one or more of a minimum value, a median value, a mean value, a maximum value, a first quartile, a third quartile and one or more measures of variation. The one or more measures of variation may comprise standard deviation.

In some embodiments, the at least one measure of a second type may comprise one or more of: an average of increasing values, an average of decreasing values, a ratio of increasing values to all of the values and a ratio of decreasing values to all of the values.

In some embodiments, the at least one measure of a second type may comprise: at least one measure of central tendency of the drilling variable; and at least one measure of the distribution of the drilling variable. The at least one measure of a second type may further comprise at least one of an average of increasing values and an average of decreasing values and/or at least one of a ratio of increasing values to all of the values and a ratio of decreasing values to all of the values.

In some embodiments, outliers may be removed from the data comprising at least one drilling variable prior to determining the plurality of characteristic measures.

In some embodiments, observations may be removed from the data comprising at least one drilling variable if data comprising the observation is missing, prior to determining the plurality of characteristic measures.

In some embodiments, the output indicating the determined groups of the drilled holes may further indicate the at least one physical characteristic of rock, based on the determined groups. The at least one physical characteristic of rock may comprise rock hardness.

In some embodiments, the process of applying unsupervised learning to the plurality of characteristic measures may be configured to determine at least three groups of the drilled holes.

In some embodiments, the method further comprises causing the determined groups of the drilled holes to be provided to a controller of at least one mining apparatus operating in relation to the drilled holes. The mining apparatus may comprise at least one of an autonomous vehicle, concentrator, crusher and grinder.

In some embodiments the method includes processing rock at the location of a said drilled hole based on the output indicating the determined group of that drilled hole. Examples of processing rock include blasting, extracting, crushing, grinding, sorting, concentrating and/or beneficiation of the rock.

According to another embodiment of the present disclosure, there is provided a method, comprising:
receiving or generating, at one or more computing systems, data comprising at least one drilling variable for a drill hole at a plurality of depths, wherein the at least one drilling variable is a variable affected by at least one physical characteristic of rock in the drill hole;
determining, by the one or more computing systems, a plurality of characteristic measures for the drill hole based on said at least one drilling variable across the plurality of depths of the drill hole;
applying, by the one or more computing systems, the plurality of characteristic measures to a model, wherein the model is determined from the unsupervised learning of the method of any one of the previous embodiments and assigning at least one depth of the drill hole or the drill hole to a group of the model determined by the unsupervised learning.

In some embodiments the model may indicate a plurality of groups and each group indicates at least one physical characteristic of rock. The at least one physical characteristic of rock may comprise rock hardness.

In some embodiments assigning the drill hole to the group of the model determined by the unsupervised learning may comprise:
assigning, by the one or more computing systems, each depth of the drill hole to one of the groups of the model;
determining, by the one or more computing systems, a group of the model that corresponds to the majority of the depths of the drill hole; and
assigning, by the one or more computing systems, the determined group that corresponds to the majority of the depths of the drill hole to the drill hole.

In some embodiments the at least one depth of the drill hole or the drill hole may be added to the group of the model determined from the unsupervised learning.

In some embodiments the unsupervised learning of the method of any one of previous embodiments may be re-performed in response to the addition of the at least one depth of the drill hole or the drill hole to the group of the model determined from the unsupervised learning.

According to another embodiment of the present disclosure, there is provided a non-transient computer storage comprising instructions that, when executed by a computing system, cause the computing system to perform the method of any one of the embodiments described above.

In accordance with an embodiment of the present disclosure an exemplary method for determining a model of rock hardness for an individual drill hole having a plurality of drilling variable observations (such as MSE at each 0.1 depth interval) includes:
1) determining quartiles (e.g. a first quartile, a third quartile) of the drilling variable observations. The determined quartiles may be characteristic measures for the drill hole;
2) determining the drilling variable observations that separate each quartile, e.g. (min) 70,000; 1-25% under 100,000; 26-50% under 125,000; 50-75% under 175,000;

under 100% (max) under 220,000;
3) determining a mean and standard deviation of the drilling variable observations for each quartile. The determined mean and standard deviation for each quartile may be characteristic measures for the drill hole; and
4) applying unsupervised learning to the characteristic measures for the drill hole to determine a model of rock hardness at the individual hole.

In accordance with another embodiment of the present disclosure an exemplary method for determining a model of rock hardness for a mining environment includes:
1) determining a mean of a drilling variable (e.g. MSE) of a plurality of drilled holes. The determined mean may be a ‘cross-hole variable’ as is described herein;
2) determining a standard deviation of the drilling variable of the plurality of drilled holes. The determined standard deviation may also be a ‘cross-hole variable’ as is described herein;
3) comparing drilling variables for a drill hole with respect to the cross-hole variables and remove drilling variables that lie outside of a maximum or minimum value from the cross-hole variables;
4) comparing drilling variables for the drill hole with respect to the cross-hole variables to determine drilling variables that sit within 1, 2, 3 and 4 deviations from the determined mean. The deviations may represent areas of rock that is harder or easier to drill through;
5) removing drilling variables that lie outside of 5 deviations;
6) determining the proportion of drilling variable observations of an individual drill hole that falls within each deviation from the determined mean e.g. 60% normal 20% 1 deviation 20% 2 deviations and 10% 3 deviations. The proportion of drilling variables in each deviation represent characteristic measures of the drill hole;
7) repeat step (6) for each drill hole of the plurality of drill holes; and
8) apply unsupervised learning to the characteristic measures for the drill holes to determine a model of rock hardness of the mining environment.

Further aspects of the present disclosure and further embodiments of the aspects described in the preceding paragraphs will become apparent from the following description, given by way of example and with reference to the accompanying drawings.

### BRIEF DESCRIPTION OF THE DRAWINGS

FIG. 1 illustrates a flow diagram of a method for automatic rock recognition in accordance with an embodiment;

FIG. 2 illustrates a flow diagram of the optional pre-data processing step shown in FIG. 1;

FIGS. 3a-3b illustrate flow diagrams of example processes for determining characteristic measures;

FIG. 3c illustrates an example data set of determined characteristic measures;

FIG. 4 illustrates a flow diagram of an example process for unsupervised learning;

FIGS. 5 and 6a-6b illustrate graphical plots of the distribution and hardness of various types of rocks obtained from an application of unsupervised learning;

FIG. 7a illustrates a diagram of a system for automatic rock recognition in accordance with an embodiment;

FIG. 7b illustrates a flow diagram of a method for automatic rock recognition in accordance with another embodiment;

FIG. 8 illustrates a diagram of a computing system which may be used to implement the methods of the proceeding flow diagrams and used within the rock recognition system of FIG. 7a;

FIG. 9 illustrates a graphical plot of experimental data from an application of a prior art method in a real-world mine environment; and

FIG. 10 illustrates a graphical plot of experimental results from an application of an embodiment of the present disclosure in a real-world mine environment.

### DETAILED DESCRIPTION OF EMBODIMENTS

One method for estimating the distribution and properties of various rock types in the subsurface of a mine site involves methods of rock recognition that relate drilling data or “measurement-while-drilling” (MWD) data to physical properties of the rocks being drilled, in particular in a blast hole. The MWD data of a known distribution of rock types may be evaluated by geologists in order to determine a classifier, which is then used to classify any new incoming MWD data. Models that utilize this MWD data may classify the rock as having a single hardness type, for example, soft rock or hard rock. However, this process of rock recognition is often a cumbersome, inefficient and inaccurate process.

Efficiency may be gained by seeking to automate aspects of the estimation process. This presents problems in potential loss of accuracy or other potential loss of utility, due to replacing an expert (i.e. a geologist) with automation. An example problem applicable across various estimation processes is the variability of hardness within a given rock type and biases that are introduced in the MWD data, for example, as a result of different drill types being used to perform the drilling, different operators conducting the drilling, variations due to manual drilling operations, different geological properties of the drilled holes, use of different drill bit sizes while drilling or variations arising from previous blasting performed in the environment.

Inaccuracies in the identification and classification of rock types within a mining environment can have significant impacts on the downstream separation of valuable concentrates from invaluable rejects or tails. Inaccuracies can also have a significant impact on mine planning operations. For example, inappropriate discrimination of soft rock and hard rock can result in longer crushing, grinding and milling operations for mineral extraction than necessary, thereby wasting resources. In another example, misclassification of soft rock as hard rock may result in the soft rock being milled as if it was a hard rock, which may result in the grain size of the rock becoming too fine for efficient separation and recovery of valuable minerals from invaluable minerals by a concentrator. For example, the fine grain size of the rock may adversely affect froth flotation. In another example, inappropriate discrimination of soft rock and hard rock may result in inappropriate quantities of explosives being used in blasting operations. For example, misclassification of hard rock as soft rock may result in less explosives being used in blasting operations and inappropriate fragmentation of the rock for excavation.

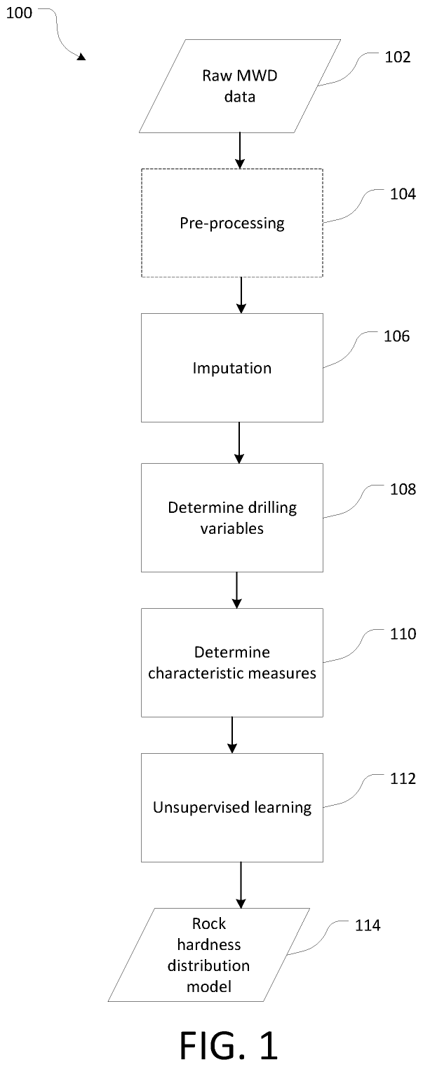

FIG. 1 illustrates a method 100 for automatic rock recognition in a mining environment. The method 100 is performed at, or by, one or more computing systems. MWD data 102 is received and used in the method 100 for obtaining a rock hardness distribution model 114. The MWD data is generated in a preceding process (not shown in FIG. 1), while drilling one or more holes in a region of interest in the mining environment and includes one or more drilling variables affected by physical characteristics of the drilled rock. Example drilling variables include rate of penetration, revolution per minute, weight or force on the drill bit, pressure on the drill bit, torque on the drill bit, and drill bit size. In some embodiments all of these variables are utilised in the method 100. The MWD data is generated based on output from one or more sensors of the drilling apparatus.

The MWD data includes the depth in the hole when the measurement of the drilling variable was collected. The spatial location of the corresponding drilled hole is also recorded. The spatial location may be identified by any appropriate measure, for example as an absolute position (e.g. co-ordinates such a latitude and longitude), as a relative position (e.g. relative to a reference point of the mining site, which reference point may be the location of one of the drilled holes) or a combination of both. The position may be identified based on measurements from one or more suitable position sensors, for example a global position system (GPS) and/or a gyroscope and/or a ranging system for determining the location of the drilling apparatus while the drilling variables are measured. The MWD data may be received as a contiguous block of data or as a separate blocks, for example from different sensors at the same or different times.

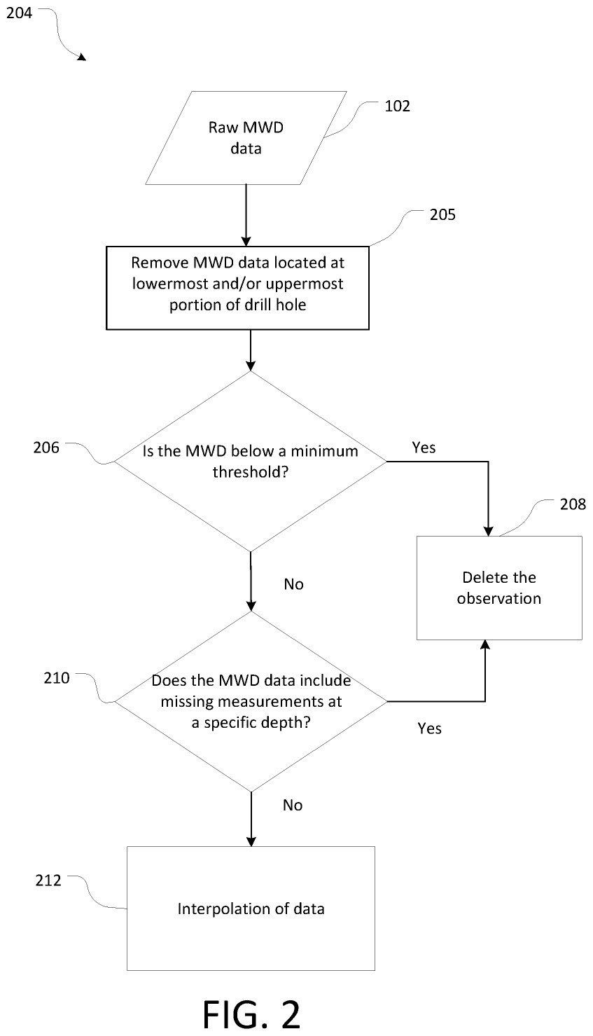

In some embodiments, the MWD data is pre-processed 104 to remove MWD data that has the potential to reduce inaccuracy in the estimation. Removed data may include one or more of data at the top and/or bottom of the drilled hole and data that is an identifiable outlier. In some embodiments if the MWD data at a depth is identified as an outlier, then all MWD data for that hole at that depth is removed. One example of pre-processing the MWD data is described in further detail below with reference to FIG. 2.

In some embodiments, imputation techniques 106 are applied to the data from pre-processing 104. Imputation techniques may be applied to the data to replace unavailable data measurements with measurements derived from the remaining MWD data available for the drilled hole or with a default value. The imputation techniques may be numerical or categorical techniques. Numerical imputation techniques may include replacing unavailable data measurements with a known value or a calculated median or mean value derived from the remaining MWD data for the drilled hole. In one example, unavailable data for the bit size or drill rig type of the drill may be replaced with a determined value of the drill bit size. In some embodiments, the imputation provides a replacement for observations that have been removed by pre-processing. The imputation may be applied to observations removed from the mid-portion of the drill hole (i.e. imputation is not performed in relation to removed observations at the uppermost and lowermost portions of the drill hole).

In other embodiments pre-processing and/or imputation are not performed. For example, the raw MWD data may be used in step 108.

With reference to steps 108-110 in FIG. 1, at least one drilling variable is identified or determined from the MWD data 106 at each depth in each of a plurality of drilled holes, for use in determining at least one characteristic measure for each of the drilled holes. In some embodiments, a drilling variable is based on a combination of a plurality of other drilling variables. The combination may be determined by modelling, for example applying an optimisation or learning algorithm to the selected variables against drill holes with known or previously determined characteristics. Therefore and by way of example, the at least one drilling variable may include any one or combination of: rate of penetration, revolution per minute, weight or force on the drill bit, pressure on the drill bit, or torque on the drill bit.

An example combination of drilling variables is a measure referred to as the “Mechanical Specific Energy (MSE)”, which has been found to be related to rock hardness, in particular substantially proportional to the rock hardness. Inaccuracies and biases introduced while obtaining MWD data, for example as described above, may cause significant difficulties in directly relating the MWD data to a specific rock type. Instead of directly relating MWD data, for example the data imputed from process 106, to a specific rock type, the connection between the MWD data and the rock types may be made indirectly by measures like the MSE that have a known or determinable relationship with rock hardness and therefore may be used as a proxy of rock hardness.

The MSE at various depths in each of the holes drilled in the mining environment may be calculated according to:

$${E}_{S} ( \frac{kJ}{{m}_{3}} ) = \frac{F}{A} + \frac{2 π NT}{AV} \qquad ( Equation 1 )$$

where F is the thrust on the drill bit (kN), A is the area removed by the drill bit (m²), N is the rotation speed of the drill bit (rps), T is the rotation torque of the drill bit (kN·m), and V is the drilling speed (m/s).

Another example of a useful combination of drilling variables that has a known or determinable relationship with rock hardness and therefore may be used as a proxy of rock hardness, is Adjusted Penetration Rate (APR). The APR at various depths in each of the holes drilled in the mining environment may be calculated according to:

$$APR = \frac{PR}{( PP * \sqrt{RP )}} \qquad ( Equation 2 )$$

where PR is the measured penetration rate, PP is the measured pull down pressure, and RP is the measured rotation pressure.

In some embodiments, the depths at which the MSE, APR or other drilling variable is determined correspond to or substantially corresponds to the depths at which MWD observation data is available (e.g. based on what is included in the raw MWD data). In other embodiments the MSE, APR or other drilling variable is determined for a subset of depths at which MWD observation data is available or by interpolation or other techniques to more depths than the MWD observation data is available.

At step 110 in FIG. 1 characteristic measures (examples of which are provided herein below) of a drilling hole are determined from a comparison of a distribution of one or more drilling variables of the drill hole with respect to a related or the same drilling variable across a plurality of the drilled holes (a “cross-hole” variable). The combined use of a distribution of drilling variables within a hole with a distribution of like drilling variables across a plurality of drilled holes has been found to provide an effective configuration for machine learning to provide estimates of rock hardness distribution, described below. The plurality of the drilled holes may be up to all of the drilled holes in the raw MWD data, subject to any pre-processing that removes drill holes from the analysis. The plurality of drilled holes may coincide with a region of a mine site to which a rock hardness distribution analysis is to be applied. The plurality of drilled holes may be substantially evenly spaced apart within the region. The plurality of drilled holes may be a collection of a group of adjacent holes or at least adjacent holes for which MWD data is available.

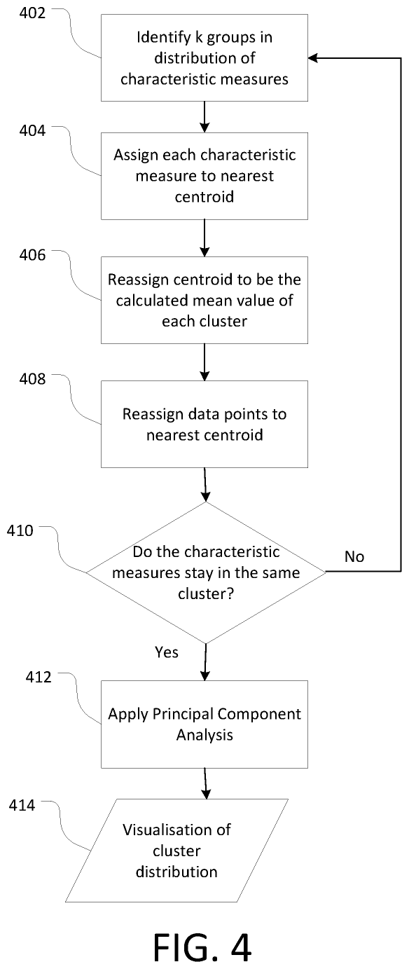

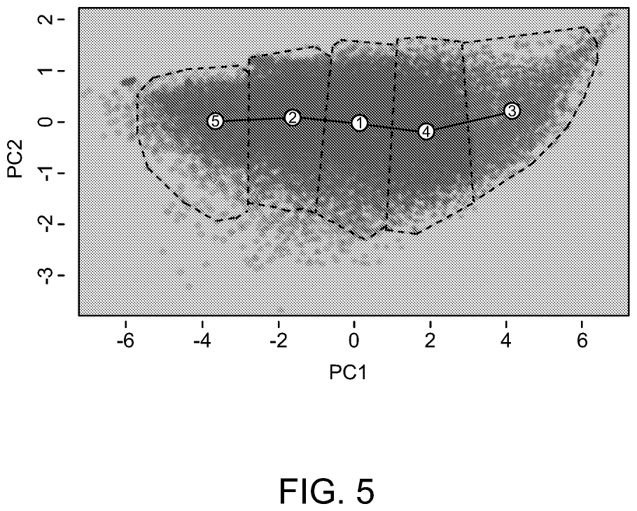

At step 112 unsupervised learning is performed on the distribution of characteristic measures to provide a rock hardness distribution model 114. One exemplary method of unsupervised learning is described in further detail below with reference to FIG. 4. The rock hardness distribution model 114 may be provided as data, or as a graphical representation for example as shown in FIG. 5, or both.

In some embodiments the method 100 further includes processing rock from the location of one or more of the drilled holes, based on the rock hardness distribution model 114 or a part thereof. For example, the processing may be based on an output forming part of the rock hardness distribution model 114 that indicates an estimated rock hardness for the drilled hole. The estimated rock hardness may correspond to the determined group of that drilled hole. Examples of processing rock include blasting, extracting, crushing, grinding, sorting and/or concentrating the rock. For example, rock from the location of one or more drilled holes that is relatively hard may require more explosives for the bench containing the rock. In another example the duration of crushing and/or grinding of rock at the one or more drilled holes that has been extracted and transported to a processing site may be controlled based on the rock hardness information. The processing site may be at or near the mine site, or may be remote from the mine site. This control may be automatic, based on data representing the rock hardness and based on tracking the rock from the mine site to the crushing and/or grinding stages. In a further example the rock is sorted and/or blended based on hardness, for example to ensure relatively hard rock is generally separated from relatively soft rock, or blended to achieve a desired aggregate/average hardness, as appropriate to better suit downstream processing. It will be appreciated that references to rock at or from the location of a drilled hole include rock at the mine site surrounding the drilled hole.

In one embodiment, the MWD data may be pre-processed according to the method 204 illustrated in FIG. 2 to remove or reduce inaccuracies and biases introduced while obtaining the MWD data 102. In one example, when blasting is performed at a mine bench the rock surrounding the mine bench may become fragmented such that when this area is subsequently drilled, inaccuracies and biases are introduced into the MWD data. To account for these inaccuracies and biases, MWD data located in a lowermost portion and/or uppermost portion of the drill hole may be removed 205. In one example, MWD data located 0-2.0 meters from the surface of the drilled hole are removed, 0-1.0 meters from the surface of the drilled hole are removed, and more preferably between 0-1.5 meters from the surface of the drilled hole are removed. In another example, MWD data located 0-0.5 meters from the base of the drilled hole are removed, 0-1.5 meters from the base of the drilled hole are removed, and more preferably 0-1.0 meters from the base of the drilled hole are removed. The portion of the data considered to be the lowermost portion and/or uppermost portion of the drill hole may be based on another measure, for example a proportion of the depth of the hole, for instance the top or bottom 0.5%, 1%, 5% or other selected percentage of the measurements.

In another example, when MWD data corresponding to a depth in the drilled hole does not include a measurement, or includes a measurement below a predetermined threshold, for one or more of the drilling variables, each measurement at the corresponding depth in the drilled hole is removed 206-210. For instance, in response to a determination that a measurement for pressure on the drill bit corresponding to a depth of 2.0 meters is below a minimum threshold (step 206), then that observation is removed from the MWD data and the observations at 2.0 meters for the other drilling variables are also removed from the MWD data. For example, each MWD data measurement for rate of penetration, revolution per minute, weight or force on the drill bit, and torque on the drill bit recorded at a depth of 2.0 m is removed from the MWD data set in addition to removing the measurement for pressure on the drill bit, even though they are above a minimum threshold set for their respective measurements. In another example, in response to a determination that a measurement for torque on the bit corresponding to a depth of 3.0 meters is unavailable (step 210) each MWD data measurement for rate of penetration, revolution per minute, weight or force on the drill bit, pressure on the drill bit or torque on the drill bit corresponding to a depth of 3.0 meters is removed (step 208).

Whilst the process described with reference to FIG. 2 determines observations that are below a minimum threshold or which have a missing measurement, the deletion of observations at particular depths may be based on alternative or additional filter criteria. Other filter criteria may include a maximum threshold or a maximum rate of change of a measurement between measurements or across a depth range. Still further filter criteria may specify boundaries for combinations of measurements that have a known relationship to each other.

In some embodiments, interpolation 212, for example linear interpolation, is applied to the raw MWD data 102 modified by preceding pre-processing steps, which may include one or more of the removal of observations described with reference to steps 205 to 210 of FIG. 2 and/or removal of observations based on other determinations. In some embodiments, interpolation is used to vary the resolution of the MWD data for example to provide data at depth intervals of 0.1 meters in the drill hole when one or more of the drilling variables are measured at larger intervals or smaller intervals or at varying or different intervals within or across drill holes.

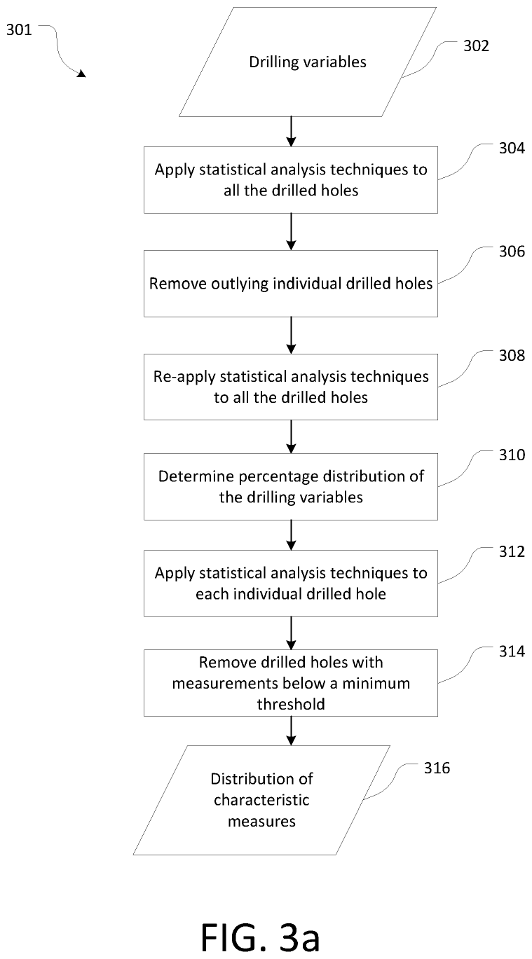

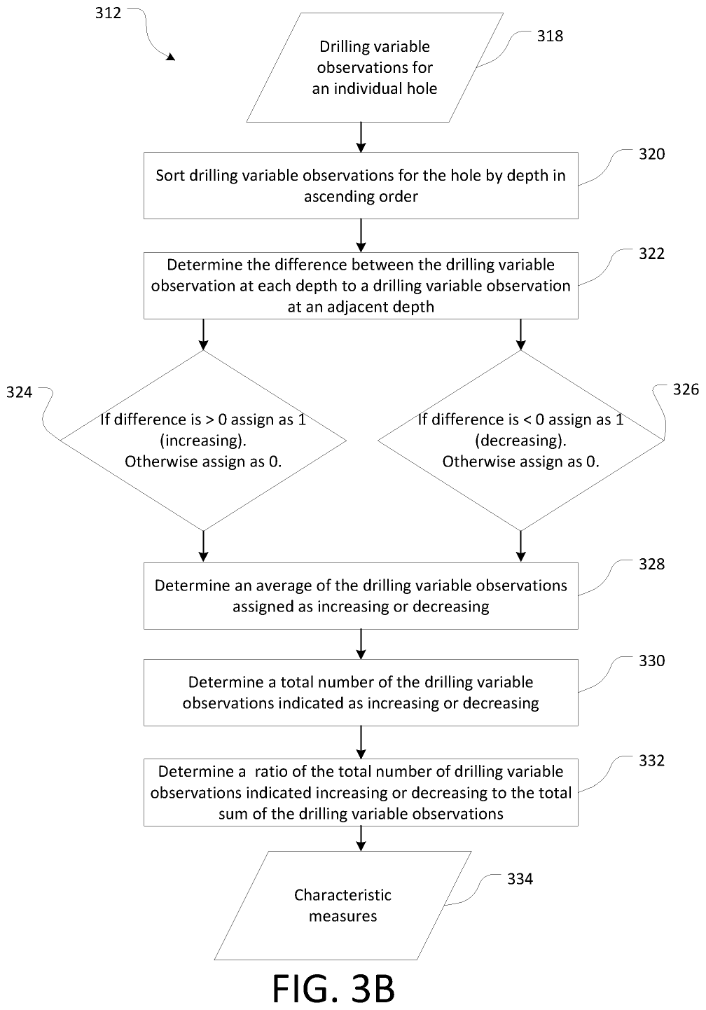

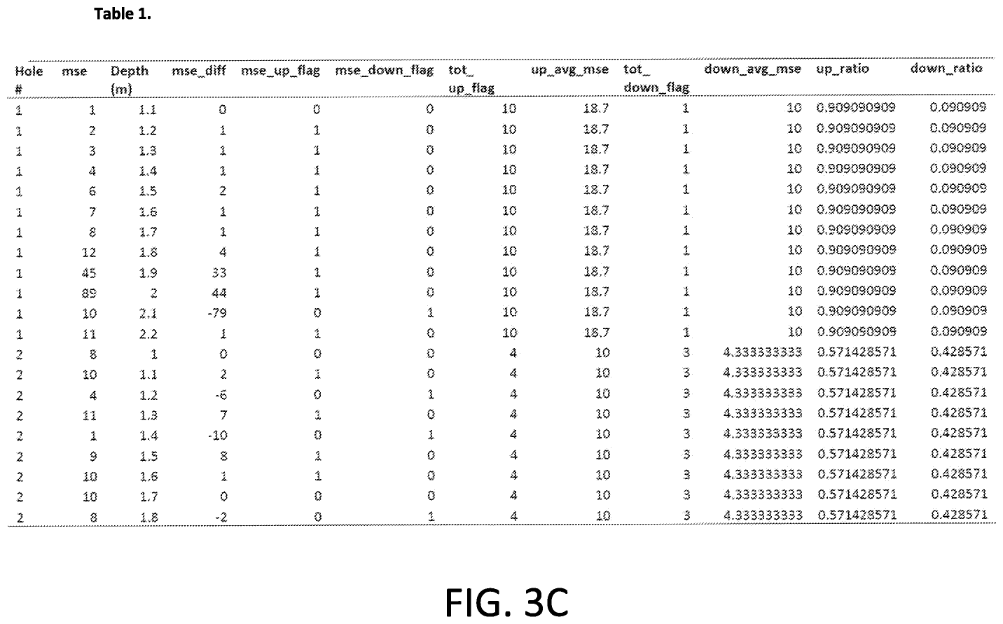

FIGS. 3a-3b illustrate exemplary methods for determining characteristic measures of a drilling hole, involving a comparison of a distribution of one or more drilling variables of the drill hole with respect to a cross-hole variable. The cross-hole variable may be determined by statistical analysis techniques 304 applied to the determined drilling variable(s) 302 across the plurality of the drill holes. An example cross-hole variable includes a measure of central tendency, for example the mean or median (or both) of a drilling variable of the plurality of drilled holes. A mean or median MSE or APR across the plurality of drilled holes is an example cross-hole variable.

Another example cross-hole variable is a measure of distribution or dispersion or variation of a drilling variable, for example the standard deviation. For example the standard deviation of the MSE or APR across the collection of drilled holes may be a cross-hole variable. In one embodiment, the standard deviation includes a first, a second, a third, and a fourth standard deviation from a determined mean (in both directions). In another embodiment, the standard deviation includes a first, a second, a third, a fourth, and a fifth standard deviation from the mean. In other embodiments more than five or less than four groups may be used. The following description herein is made with reference to standard deviations. However, it will be appreciated that in other embodiments the dividing line between groups need not correspond to integer standard deviation intervals and that in still other embodiments a measure of variation other than standard deviation may be used as a basis for determining the demarcations between groups.

In some embodiments, the cross-hole variable is determined by a process that removes some measurements of the drilling variable from the determination. The removal may be by an iterative process that removes outliers in one or more iterative determinations of the drilling variable. For example, the process may include step 306, in which individual drilled holes that have a value for the relevant variable (e.g. MSE) that lies outside of a maximum or a minimum value or distance from the calculated cross-hole mean is removed from the data set. A variable that lies outside of a maximum or a minimum value from the mean may be viewed as an “outlier”. In some embodiments, any individual drilled hole with any outlier data may have its data removed from the data set for the purposes of determining the cross-hole variable. In other embodiments only the specific data that is identified as an outlier is removed, with all other data for that drill hole retained for use in determining the cross-hole variable. Removing the outliers prior to unsupervised learning being performed may provide a more accurate distribution of characteristic measures and rock hardness.

In some embodiments, a process to remove outliers includes using a box plot method. In some embodiments a process includes ordering, for an individual drilled hole the relevant variable (e.g. MSE) from smallest to largest and assigning them to quartiles calculated from the calculated mean determined at step 304. The quartiles may be graphically represented by a box plot with a maximum and minimum variability for each quartile being represented as a whisker extending from a respective box. Drilling variables located outside of the box-and-whisker plot may correspond to an outlier and may be removed, automatically or by manual selection. Divisions other than quartiles may be used in other embodiments.

After any outliers have been removed at step 306 in FIG. 3a, the statistical analysis techniques in step 304 are re-applied. For example, re-applying the statistical analysis techniques 308 includes re-calculating the mean and/or standard deviation of the drilling variable(s) of the plurality of drilled holes.

In some embodiments process 306 of removing outliers is repeated after the process 308 of re-applying the statistical analysis techniques. Processes 306 and 308 may be iterated, for example until there are no longer outliers to remove, or only a threshold number or less of outliers are removed, or a certain number of iterations have been completed, which may be a fixed number.

At step 310, the drilling variable or variables of an individual drill hole (e.g. MSE at each observation depth) of the collection of drill holes is/are considered and their distribution compared to a cross-hole variable, to determine a characteristic measure. A characteristic measure of the drill hole is a measure indicating a relative value of the measured drilling variable(s) for an individual drill hole in comparison to corresponding cross-hole variable(s). As both the drilling variable measurements of an individual drill hole and the corresponding cross-hole variable have respective distributions, determining the relative value includes comparing the respective distributions, in particular determining a location or position of a distribution of the drilling variable for an individual drill hole with a distribution associated with the corresponding cross-hole variable.

Example characteristic measures indicating relative value include measures indicating distance from a measure of central tendency, for example distance from the mean. A simple example of a process to determine a relative value is to compare the mean of a drilling variable of an individual drill hole to the standard deviation for a cross hole variable determined for the same drilling variable. For instance, the process may comprise determining the mean of the MSE for a drill hole and determining as a characteristic measure how many standard deviations the mean of the MSE for that drill hole is from the mean of MSE's across a plurality of drill holes.

In other embodiments, a plurality of characteristic measures indicating relative value may be determined. For example, instead of determining a single mean for the MSE for a drill hole, a plurality of means may be determined, one for each of a plurality of depth ranges within the drill hole. For example, the mean MSE of MSE measured at each 0.1 m across each 1 metre interval may be determined. Characteristic measures of the drill hole are therefore the number of standard deviations from the cross-hole mean the mean determined for each 1 metre interval is. For a drilling hole with 10 metres of drilling variable measurements (e.g. after pre-processing, if any) there will be ten characteristic measures.

The characteristic measure may be discretised. For example the mean of the MSE for a drill hole or the mean of the MSE for a portion of a drill hole, may be determined to be in one of the groups (e.g. standard deviations), determined from steps 304 to 308, with the determined group representing a characteristic measure.

In some embodiments, the relative value of the measured drilling variable(s) for an individual drill hole in comparison to corresponding cross-hole variable(s) is a proportional value with respect to the discretised characteristic measure. For example, in some embodiments the comparison includes determining the proportion of, or a measure indicative of the proportion of, the drilling variable observations of the individual drill hole that falls within each group (e.g. standard deviation) of the cross-hole variable. The determination may be made for the drilling variable (e.g. MSE) for each individual observation (e.g. at each 0.1 m depth interval) or made with reference to a drilling variable determined for a group of observations. An example group of observations is the mean MSE across a 0.5 m depth interval.

By way of example, due to variations across a mine site, one drilling hole may have all of its drilling variable observations above the mean and within one standard deviation whereas another may have measurements distributed across two or more standard deviations. The proportion of measurements in each group represent characteristic measures of the drilled holes.

Step 310 is applied to drill holes in the collection of drill holes, up to all of the collection of drill holes.

At step 312, further statistical analysis of the drilling variable(s) of each drilled hole is performed to determine characteristic measure(s) for the drill hole. In some embodiments, a characteristic measure is based on one or more drilling variables across a plurality of depths of the drilled hole. For example a characteristic measure may be determined across substantially the entirety of the drilled hole, less any portions removed in pre-processing 104 or otherwise. Example characteristic measures of this category include a measure of central tendency such as an average, which may be the mean or median (or both). For the example drilling variable of MSE, a mean MSE and a median MSE of a drill hole may be determined characteristic measures for that drill hole. In some embodiments, the determined characteristic measures also or alternatively include one or more of: a maximum, a minimum, a standard deviation, a first quartile, a third quartile. Further additional or alternative measures include the measures explained in more detail herein of: a mean of increasing values, a mean of decreasing values, a ratio of increasing values to all of the values and/or a ratio of decreasing values to all of the values.

In some embodiments, when the number of drilling variable observations for a drilled hole is below a minimum threshold, the drilling variable observations and statistical properties calculated for the respective drilled hole are removed from the distribution determined in step 310 and/or step 312, at step 314. The removal process may occur prior to steps 310 and/or 312 in other embodiments.

Accordingly, in some embodiments, a collection or distribution of a plurality of characteristic measures for each of a plurality of drilled holes is generated 316.

FIG. 3b illustrates an exemplary method 312 for determining characteristic measures 334 for an individual drilled hole including a mean of increasing, or decreasing, values and a ratio of increasing, or decreasing values. A simple example data set for illustrative purposes is shown in Table 1 shown in FIG. 3c. In the example provided in FIG. 3c, the drilling variable is MSE, however, it will be appreciated that the drilling variable may be different, for example any one or combination of: MSE, rate of penetration, revolution per minute, weight or force on the drill bit, pressure on the drill bit, or torque on the drill bit.

In some embodiments, the drilling variable observations obtained for an individual hole 318 are sorted by depth in ascending order 320. In other embodiments, the drilling variable observations obtained for an individual hole 318 may be sorted by depth in descending order. It will be appreciated that the sorting operation need not rearrange any data, but may instead consider observations represented by the data in an order based on depth. For each depth in the hole, the difference between the drilling variable observation at that depth to a drilling variable observation recorded at an adjacent depth is determined at step 322.

At step 324, if the difference in the drilling variable observation is greater than 0, the drilling variable observation is associated with an indicator (for example, a numeral 1) indicating that the drilling variable observation is increasing with depth. If the difference in the drilling variable observation is not greater than 0, the drilling variable observation is associated with an indicator that does not indicate that the drilling variable observation is increasing with depth (for example, a numeral 0). In the example shown in Table 1, MSE measures corresponding to depths of 1.2-2 m are associated with the indicator “1” in the “mse_up_flag” column indicating that “mse” is increasing with depth. Further, the MSE measurement corresponding to a depth of 2.1 m is associated with the indicator “0” in the “mse_up_flag” column indicating that “mse” is not increasing with depth.

At step 326, if the difference in the drilling variable observation is less than 0, the drilling variable observation may be associated with an indicator (for example, a numeral 1) indicating that the drilling variable observation is decreasing with depth. If the difference in the drilling variable observation is not less than 0, the drilling variable observation may be associated with an indicator that does not indicate that the drilling variable observation is decreasing with depth (for example, a numeral 0). In the example shown in Table 1, the MSE measurement corresponding to a depth of 2.1 m is associated with the indicator “1” in the “mse_down_flag” column indicating that “mse” is decreasing with depth. MSE measures corresponding to depths of 1.2-2 m and 2.2 m are associated with the indicator “0” in the “mse_down_flag” column indicating that “mse” is not decreasing with depth.

While steps 324 and 326 are shown as parallel steps in FIG. 3b, they need not be parallel operations. For example step 326 may be completed first, followed by step 324. In some embodiments, only step 324 and not step 326 may be performed, in which case instances of no change in the drilling variable observation can be either filtered using another mechanism or allocated an mse_up_flag or mse_down_flag based on a fixed or variable rule by the system.

At step 328, an average of all the drilling variable observations indicated to be increasing, or decreasing, with depth from each of steps 324 and 326 are determined. In the example shown in Table 1, an average of the “mse” measures corresponding to depths 1.2-2 m and 2.2 m, which have been indicated as increasing, is determined and recorded in the “up_avg_mse” column as “18.7”. This is a determined characteristic measure.

At step 330, a total number of the drilling variable observation indicated as increasing, or decreasing, with depth from each of steps 324 and 326 are determined.

In the example shown in Table 1, the total number of “mse” measures indicated as increasing with depth for “Hole #1” is shown in the “tot_up_flag” column as “10”. This is another determined characteristic measure.

At step 332, a ratio of the total number of drilling variable observations indicated as increasing, or decreasing, with depth from each of steps 324 and 326 to the total sum of the drilling variable observations for the individual hole is determined. In the example shown in Table 1, the ratio of the total number of “mse” measures indicated as increasing with depth to the total sum of the mse measures for “Hole #1” is shown in the “up_ratio” column as “0.909090909”. This is another determined characteristic measure.

A plurality of characteristic measures are used in a machine learning process. The plurality of characteristic measures used in the machine learning process include at least one characteristic measure determined by comparison of one or more drilling variables of the drill hole with a related or the same drilling variable across a plurality of the drilled holes (i.e. a cross-hole variable) and at least one characteristic measure of the drilling hole without reference to a cross-hole variable.

In some embodiments, unsupervised learning is performed on the distribution of characteristic measures from step 316 of FIG. 3a and step 334 of FIG. 3b. Unsupervised learning is used to organise the drilled holes into groups. The groups indicate the physical characteristics that the drilling variable is related to, in particular hardness of rock within the drilled holes. In some embodiments, the unsupervised learning involves applying statistical analysis techniques in the form of clustering whereby a predetermined threshold value is applied to the distribution of characteristic measures corresponding to boundaries between the clusters. Clustering may involve hierarchical clustering, partitional clustering or a combination of hierarchical and partitional clustering. Partitional clustering includes methods such as K-means, where data points are assigned to the nearest centre and the number of clusters are predefined. Exemplary methods of K-means clustering include the Elbow method, the Silhouette method, or the Gap statistic method. Hierarchical clustering does not require the number of clusters to be predefined.

In some embodiments, unsupervised learning is performed using a frequentist approach that uses probabilities of observed and unobserved data. In comparison to Bayesian approaches of unsupervised learning that use probabilities of data and probabilities of a hypothesis, frequentist approaches do not use or calculate the probability of the hypothesis and do not require construction of a prior. Frequentist approaches to unsupervised learning may provide improved predictions of rock hardness when geology within an area changes.

FIG. 4 illustrates an exemplary embodiment of an elbow method of K-means clustering performed on the distribution of characteristic measures 316. At step 402, a predetermined number of clusters are identified from the distribution of characteristic measures. In one embodiment, the predetermined number of clusters is selected from a range between 3-9, or between 5-7, or selected to be 5 clusters. In some embodiments the selected number of clusters into which to group the drilled holes may match the number of characteristic measure groups used in steps 304 to 308 of FIG. 3a. In some embodiments, in which validation data is available to evaluate the estimate, K-means clustering is performed for a plurality of cluster numbers, for example two or more from the range of 3 to 9, and the performance of the resulting models evaluated against the validation data. The best resulting model may then be selected for use in forming an estimate in relation to a mine site.

Each characteristic measure may then be assigned to a nearest centroid of a respective cluster at step 404. For each cluster, a mean of the characteristic measures corresponding to the respective cluster may be calculated and the centroid may be reassigned so that its location in the cluster corresponds to the calculated mean 406. At step 408, each characteristic measure may be then re-assigned to the re-assigned centroid of a respective cluster determined at step 406. As a result of performing step 408, the characteristic measures may appear to move from one cluster to another. Steps 402-408 may be repeated until each characteristic measure remains located in its respective cluster 410. In some embodiments, each of the clusters may correspond to MSE values that are substantially proportional to rock hardness, where the higher MSE values correspond to hard rock and lower MSE values correspond to soft rock. For example, the five clusters may correspond to a rock hardness of hard, medium, medium hard, medium soft or soft.

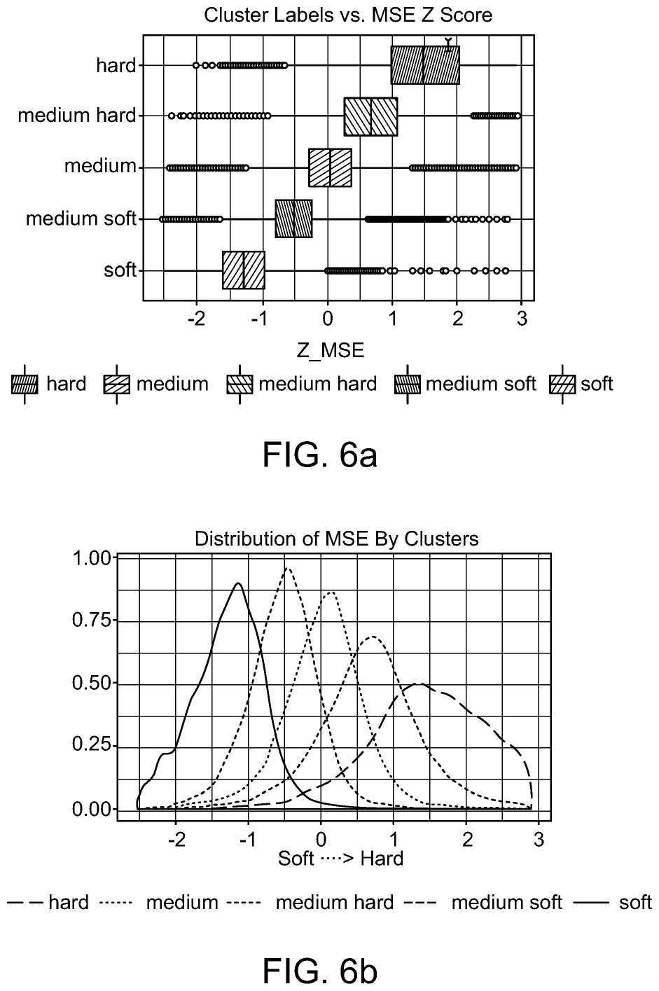

In some embodiments, principal component analysis 412 may be applied to the clusters derived from step 410 to derive a visualisation of the distribution of characteristic measures and rock hardness for each cluster 414. In one embodiment, the visualisation of the cluster distribution is a 2D visualisation as shown, for example, in FIGS. 5 and 6a-6b. FIG. 5 visualises each drilled hole in the mining environment assigned to a cluster and respective rock hardness. FIG. 6a visualises the characteristic measures of each cluster as a box and whisker plot, whereas FIG. 6b visualises the distribution of characteristic measures of each cluster and respective rock hardness.

In the foregoing description, the characteristic measures for each drilled hole apply to the entirety of the drilled hole (e.g. mean of MSE for the hole). The output of the unsupervised learning therefore classifies the entirety of the drilled hole. In other embodiments, one or more (up to all) of the drilled holes may be segmented by depth, which characteristic measures determined for each segment. The output of unsupervised learning may therefore classify each segment, providing a three-dimensional rock type classification. The cross-hole variables used to determine the characteristic measures may be either specific to each segment or may be determined across all segments.

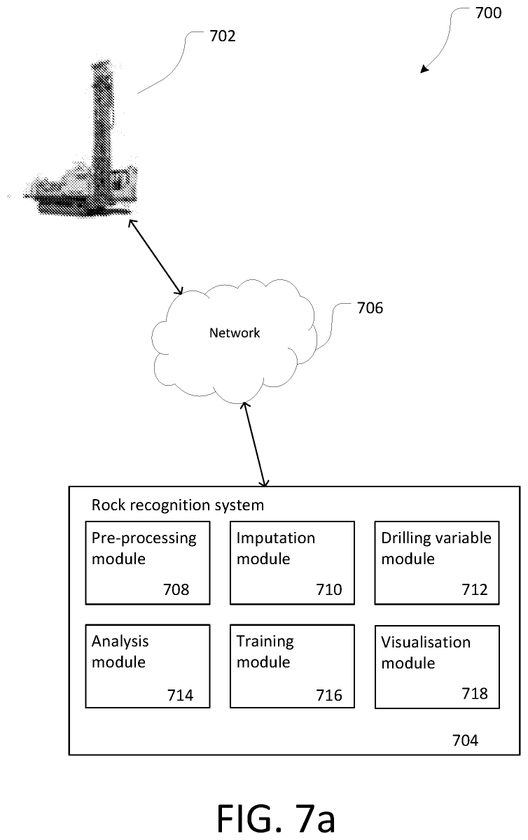

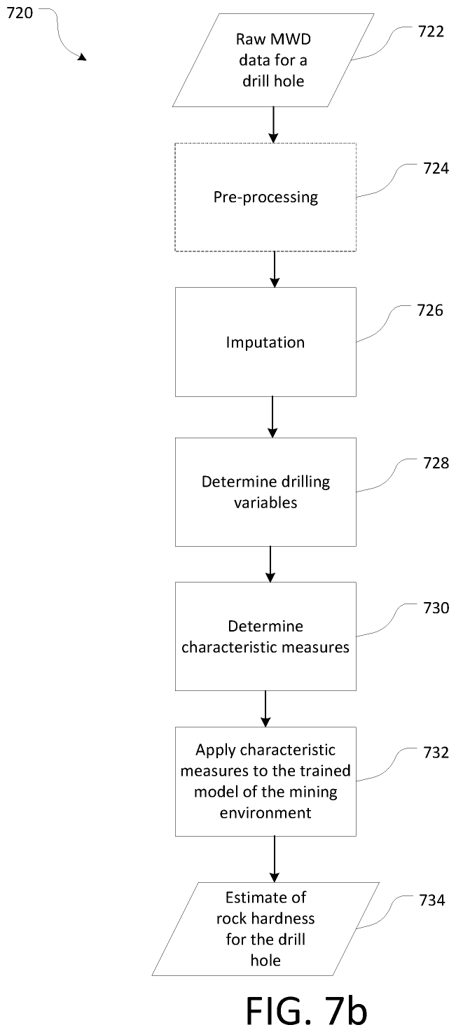

FIG. 7a illustrates an exemplary system 700 for automatic rock recognition in a mining environment including a surface drilling rig 702 in communication with a computing system 704 via a network 706. The system 700 may be used to build a model of rock hardness for a mining environment. The surface drilling rig 702 may be a manual or automatic drill rig that drills a sequence of holes into the ground that are subsequently blasted so to extract rock. Positions of the drilled holes are planned according to the mine layout and in-ground geology. The drill rig is equipped with measurement while-drilling (MWD) sensors (not shown in the drawing) which are primarily for controlling and monitoring the drilling process. The MWD sensors generate data including for example rate of penetration, revolution per minute, weight or force on bit, pressure on bit, or torque on bit. The drill rig 702 may also be equipped with positional sensors to record positional information of the drill rig and drill to enable the three-dimensional position of the drill to be determined corresponding to each sample of the MWD data. The positional information recorded by the sensor may include GPS data representing the position of the drill as well as depth data representing the depth of the drill end below the surface.

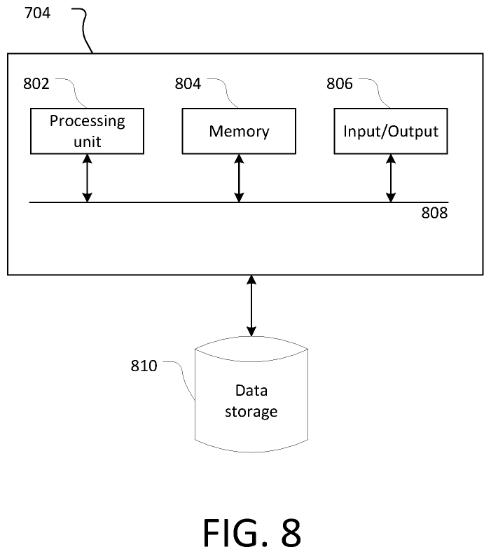

In some embodiments, the MWD sensors and positional sensors are in communication with the computing system 704 via network 706. As shown in FIG. 8, the computing system 704 may include a processor 802, a memory 804, and input/output devices 806. These components communicate via a bus 808. The memory 804 stores instructions executed by the processor 802 to perform the methods as described herein. Data storage 810 can be connected to the system 704 to store input or output data. In one embodiment, data storage can store a rock hardness distribution model 114 generated by the rock recognition system. The input/output 806 provides an interface for access to the instructions and the stored data. It will be understood that this description of a computing system is only one example of possible systems in which the invention may be implemented and other systems may have different architectures. In some embodiments, the rock recognition system can be in the form of a distributed system so that the computing system is located separate from the drill rig vehicle, for example offsite. In this case, the information obtained by the drill rig vehicle 702 can be sent to the computing system via a wireless communication network 906, for example in real time. In other embodiments, the rock recognition system can be located on the drill rig vehicle. Similarly, the processor 802 may include a plurality of processing devices, which may be distributed physically and/or logically. In other words, the computing system 704 may be one computing system or a plurality of computing systems that communicate with each other and perform parts of the processes described herein.

In the following description, reference is made to “modules”. This is intended to refer generally to a collection of processing functions that perform a function. It is not intended to refer to any particular structure of computer instructions or software or to any particular methodology by which the instructions have been developed.

In some embodiments, MWD data may be optionally be pre-processed by a pre-processing module 708. The pre-processing module is configured to remove undesirable data introduced while obtaining the MWD data at the hole as described with reference to FIG. 2. In some embodiments, the pre-processing module 708 may perform linear interpolation on the pre-processed MWD data by assigning the MWD data to equally spaced intervals, for example, at depth intervals of 0.1 meters in the drill hole.

Imputation module 710 may replace unavailable measurements in the pre-processed MWD data, or raw MWD data, with measurements derived from the remaining MWD data available for the drilled hole or with a default value. The imputation module 710 may perform numerical or categorical imputation techniques.

Drilling variable module 712 is configured to receive the imputed MWD data to identify or determine at least one drilling variable at each depth in each of a plurality of drilled holes for use in determining at least one characteristic measure for each of the drilled holes. In some embodiments, the at least one drilling variable is MSE determined from Equation 1. In other embodiments, the at least one drilling variable is any one of: rate of penetration, revolution per minute, weight or force on the drill bit, pressure on the drill bit, or torque on the drill bit.

Analysis module 714 may apply statistical analysis techniques to the drilling variables 302 as described with reference to FIGS. 3a and 3b to determine a distribution of characteristic measures for all the drilled holes in the mining environment. For example, the statistical analysis techniques may be applied to all of the drilling variables of all the drilled holes in the mining environment and/or may be applied to the drilling variables calculated at each individual drilled hole.

Training module 716 may perform unsupervised learning on the distribution of characteristic measures of the drilled holes in the mining environment. The unsupervised learning organises the drilled holes into subsets (or clusters) according to their hardness. In one embodiment, the training module 716 applies clustering techniques to the distribution of characteristic measures as described with reference to FIG. 4. The clustering techniques may involve hierarchical clustering, partitional clustering or a combination of hierarchical and partitional clustering techniques. The groups or subsets output from the training module 716 are stored in memory 804. In some embodiments, the training module 716 is re-trained, for example, periodically or in response to additional information being obtained for the mining environment and/or drilling subsequent drill holes. In some examples, the additional information may include a previously undetected error or a newly discovered void in the mining environment. Storing the groups/subsets output from the training module and retraining the training module may assist in reducing inaccuracies in identifying and classifying rock types within the mining environment.

Visualisation module 718 may apply principal component analysis to the subsets (or clusters) to derive a visualisation of the distribution of characteristic measures and rock hardness for each cluster. The visualisation of the cluster distribution may be a 2D visualisation or a 3D visualisation.

FIG. 7b illustrates a method 720 for automatic rock recognition at an individual drill hole. In some embodiments, method 720 assigns an individual drill hole to a group of the model determined from unsupervised learning 112. The method 720 is performed at, or by, one or more computing systems.

MWD data 722 for an individual drill hole is received and used in the method 720. The MWD data may be previously captured data for the individual drill hole or data obtained while drilling the individual drill hole and includes one or more drilling variables affected by physical characteristics of the drilled rock. Example drilling variables include rate of penetration, revolution per minute, weight or force on the drill bit, pressure on the drill bit, torque on the drill bit, and drill bit size. In some embodiments all of these variables are utilised in the method 720. The MWD data is generated based on output from one or more sensors of the drilling apparatus.

The MWD data includes the depth in the hole when the measurement of the drilling variable was collected. The spatial location of the corresponding drill hole is also recorded. The spatial location may be identified by any appropriate measure, for example as an absolute position (e.g. co-ordinates such a latitude and longitude), as a relative position (e.g. relative to a reference point of the mining site) or a combination of both. The position may be identified based on measurements from one or more suitable position sensors, for example a global position system (GPS) and/or a gyroscope and/or a ranging system for determining the location of the drilling apparatus while the drilling variables are measured. The MWD data may be received as a contiguous block of data or as a separate blocks, for example from different sensors at the same or different times.

In some embodiments, the MWD data is pre-processed 724 to remove MWD data that has the potential to reduce inaccuracy in the estimation. Removed data may include one or more of data at the top and/or bottom of the drill hole and data that is an identifiable outlier. In some embodiments if the MWD data at a depth is identified as an outlier, then all MWD data for that hole at that depth is removed. One example of pre-processing the MWD data is described in further detail with reference to FIG. 2.

In some embodiments, imputation techniques 726 are applied to the data from pre-processing 724. The imputation techniques applied at step 726 may be similar to those described in relation to step 106 of FIG. 1.

In some embodiments pre-processing and/or imputation are not performed. For example, the raw MWD data may be used in step 728.

With reference to steps 728-730 in FIG. 7b, at least one drilling variable (e.g. MSE, APR) is identified or determined from the MWD data 726 at each depth in the individual drill hole for use in determining at least one characteristic measure for each depth of the drill hole. By way of example, the at least one drilling variable may include any one or combination of: rate of penetration, revolution per minute, weight or force on the drill bit, pressure on the drill bit, or torque on the drill bit. At step 730, characteristic measures (e.g. a mean of increasing, or decreasing, values and a ratio of increasing, or decreasing values) may be determined for each depth of an individual dill hole by, for example, performing the method illustrated in FIG. 3b.

At step 732, the plurality of charactertistic measures determined in step 730 are applied to a model of the mining environment obtained from unsupervised learning performed in step 112 of FIG. 1 and at least one depth of the drill hole or the drill hole is assigned to a group of the model. In some embodiments, the model indicates a plurality of groups and each group of the model indicates at least one physical characteristic of rock, such as rock hardness. In one example, the model may include five groups of rock hardness (e.g. hard, medium, medium hard, medium soft or soft).

At step 734, an estimate of rock hardness of the individual drill hole can be determined from the output of step 732. In some embodiments, an estimate of rock hardness of the individual drill hole may be determined by predicting the group of rock hardness that will apply to the individual hole using the model developed or trained from unsupervised learning as described above in reference to FIGS. 1 and 7a. In some embodiments, assigning the drill hole to a group of the model obtained from the unsupervised learning includes assigning each depth of the drill hole to one of the groups of the model to obtain an estimate of the rock hardness (e.g. hard, medium, medium hard, medium soft or soft) at each depth of the individual drill hole. Statistical analysis techniques may be applied to the individual drill hole to determine a group of the model that corresponds to the majority of depths of the drill hole. The group that corresponds to the majority of the depths of the drill hole is assigned to the individual drill hole. For example, a statistical analysis technique may include calculating a proportion of, or a measure indicative of the proportion of, each rock hardness (e.g. hard, medium, medium hard, medium soft or soft) at the individual drill hole and the greatest proportion of rock hardness is assigned to the individual drill hole.

In some embodiments, the at least one depth of the individual drill hole or the individual drill hole is added to the group of the model determined from unsupervised learning 112. In one example, the estimate of rock hardness for the individual drill hole and/or the estimates of the rock hardness at each depth of the individual drill hole may be added to rock hardness distribution model 114. Updating rock hardness distribution model 114 in response to estimate/s of rock hardness for individual drill holes output from step 734 may assist in reducing inaccuracies in identifying and classifying of rock types within the mining environment.

In some embodiments, the unsupervised learning 112 performed in method 100 may be re-performed in response to the at least one depth of the drill hole or the drill hole being added to the group of the model determined by unsupervised learning. For example, the unsupervised learning 112 performed in method 100 may be re-performed in response to estimate/s of rock hardness for individual drill holes being added to the rock hardness distribution model 114.

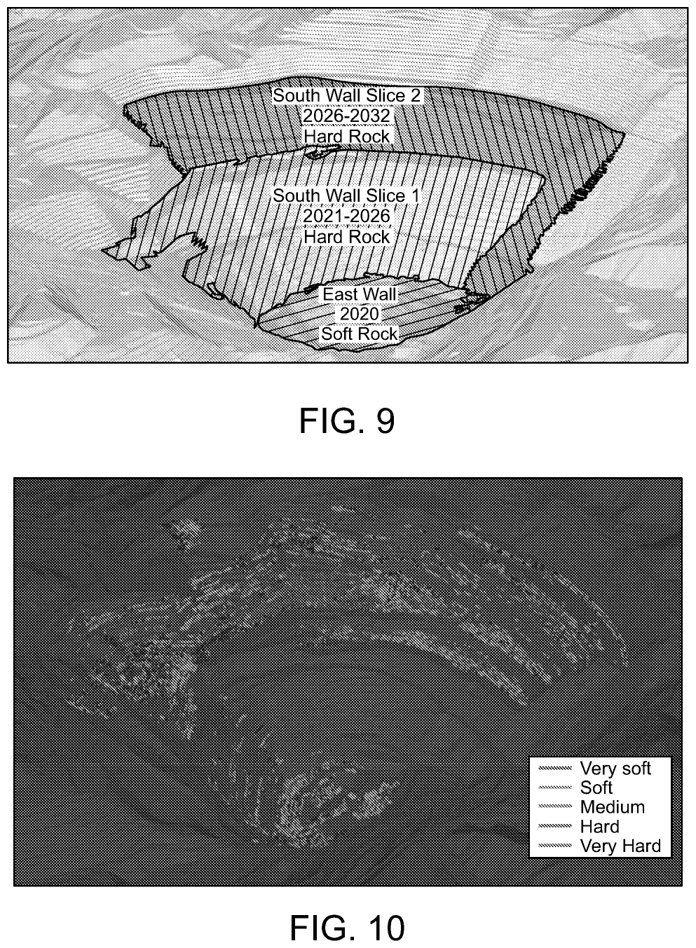

The system and methods described herein for automatically identifying and characterising rock from drilling data have been tested on data collected from benches of an existing open pit mine. FIG. 9 illustrates the distribution of rock hardness in the open pit mine derived from conventional techniques. As can be seen from FIG. 9, each of the three geographical areas of the mine (e.g. ‘East Wall’, ‘South Wall Slice 1’ and ‘South Wall Slice 2’) is assigned a single hardness (e.g. ‘Soft rock’ or ‘Hard rock’). FIG. 10 illustrates the distribution of rock hardness in the open pit mine derived from the systems and methods described herein. In contrast to FIG. 9, the rock hardness illustrated in FIG. 10 indicates the boundaries between different rock types and the variability of hardness that occurs within a given rock type and/or area of the mine, for example, hard, medium hard, medium, medium soft or soft. In one example, “South Wall Slice 2” in FIG. 10 includes hard, medium hard, medium, medium soft and soft rock types with each of these rock types being assigned a different colour. The colour variations provided between these different rock types assist in indicating the boundaries between the different rock types and the variability of hardness that occurs within “South Wall Slice 2”.

The distribution of rock hardness derived from the systems and methods described herein may provide information that can be used in the optimization of mine operations as well as mine planning and design. In one example, areas corresponding to hard and soft rock may be identified and used to optimize blast planning by improving the accuracy of calculating the quantity of explosives required. In another example, mine operations may be optimized including optimization of concentrator throughput, capacity optimized segregation, campaigning of different rock and optimized crushing, grinding and extraction of minerals.

In some embodiments an output from the unsupervised learning is provided by the computing system to one or more controllers of mine equipment for fully-autonomous or semi-autonomous operations. For example, a controller of autonomous vehicles for transporting extracted rock from a mine site may transport rock of different hardness to different locations. In another example, a controller of a concentrator may control operation of the concentrator based on the estimated rock hardness determined by the unsupervised learning. Similarly a controller of a crusher and/or a controller of a grinder may vary operation of the crusher/grinder based on the estimated rock hardness.

It will be understood that the invention disclosed and defined in this specification extends to all alternative combinations of two or more of the individual features mentioned or evident from the text or drawings. All of these different combinations constitute various alternative aspects of the invention.

1. A method, comprising:
receiving or generating, at one or more computing systems, data comprising at least one drilling variable for a plurality of drilled holes across observations at a plurality of depths, wherein the at least one drilling variable is a variable affected by at least one physical characteristic of rock in the plurality of drilled holes;
determining, by the one or more computing systems, a plurality of characteristic measures for each of the plurality of drilled holes, wherein the plurality of characteristic measures for each drilled hole comprise:
at least one characteristic measure of a first type, wherein a characteristic measure of the first type is a measure based on a comparison of a distribution of a said at least one drilling variable for the drill hole with a distribution of a related or the same drilling variable across a plurality of the drilled holes; and
at least one characteristic measure of a second type, wherein a characteristic measure of the second type is based on said at least one drilling variable across the plurality of depths of the drilled holes;
applying, by the one or more computing systems, unsupervised learning to the plurality of characteristic measures, the unsupervised learning determining groups of the drilled holes; and
generating, by the one or more computing systems, an output indicating the determined groups of the drilled holes.

2. The method of claim 1, wherein the at least one drilling variable for a plurality of drilled holes across a plurality of depths comprises a measure of mechanical specific energy (MSE).

3. The method of claim 1, wherein the at least one characteristic measure of the first type is based on mechanical specific energy (MSE).

4. The method of claim 1, wherein the at least one characteristic measure of the second type is based on mechanical specific energy (MSE).

5. The method of claim 1, wherein the distribution of a related or the same drilling variable across a plurality of the drilled holes is divided into a plurality of groups and the at least one characteristic measure of the first type is a proportion of said observations of a drill hole that are within each group.

6. The method of claim 5, wherein the plurality of groups are based on variation from a mean of the drilling variable across the plurality of drilled holes.

7. The method of claim 1, wherein the at least one characteristic measure of a second type comprises one or more of a minimum value, a median value, a mean value, a maximum value, a first quartile, a third quartile and one or more measures of variation.

8. The method of claim 7, wherein the one or more measures of variation comprise standard deviation.

9. The method of claim 1, wherein the at least one characteristic measure of a second type comprises one or more of: an average of increasing values, an average of decreasing values, a ratio of increasing values to all of the values and a ratio of decreasing values to all of the values.

10. The method of claim 1, wherein the at least one characteristic measure of a second type comprises:
at least one characteristic measure of central tendency of the drilling variable; and
at least one characteristic measure of the distribution of the drilling variable.

11. The method of claim 10, wherein the at least one characteristic measure of a second type further comprises at least one of an average of increasing values and an average of decreasing values.

12. The method of claim 10, wherein the at least one characteristic measure of a second type further comprises at least one of a ratio of increasing values to all of the values and a ratio of decreasing values to all of the values.

13. The method of claim 1, further comprising removing outliers from the data comprising at least one drilling variable prior to determining the plurality of characteristic measures.

14. The method of claim 1, further comprising removing observations from the data comprising at least one drilling variable if data comprising the observation is missing, prior to determining the plurality of characteristic measures.

15. The method of claim 1, wherein the output indicating the determined groups of the drilled holes further indicates the at least one physical characteristic of rock, based on the determined groups.

16. The method of claim 15, wherein the at least one physical characteristic of rock comprises rock hardness.

17. The method of claim 1, wherein the process of applying unsupervised learning to the plurality of characteristic measures is configured to determine at least three groups of the drilled holes.

18. The method of claim 1, further comprising causing the determined groups of the drilled holes to be provided to a controller of at least one mining apparatus operating in relation to the drilled holes.

19. The method of claim 18, wherein the mining apparatus comprises at least one of an autonomous vehicle, concentrator, crusher and grinder.

20. The method of claim 1, wherein the output indicating the determined groups of the drilled holes is generated from an unsupervised learning process.

21. A method comprising:
receiving or generating, at one or more computing systems, data comprising at least one drilling variable for a drill hole at a plurality of depths, wherein the at least one drilling variable is a variable affected by at least one physical characteristic of rock in the drill hole;
determining, by the one or more computing systems, a plurality of characteristic measures for the drill hole based on said at least one drilling variable across the plurality of depths of the drill hole;
applying, by the one or more computing systems, the plurality of characteristic measures to a model, wherein the model is determined from the unsupervised learning of a method comprising:
receiving or generating, at one or more computing systems, data comprising at least one drilling variable for a plurality of drilled holes across observations at a plurality of depths, wherein the at least one drilling variable is a variable affected by at least one physical characteristic of rock in the plurality of drilled holes;
determining, by the one or more computing systems, a plurality of characteristic measures for each of the plurality of drilled holes, wherein the plurality of characteristic measures for each drilled hole comprise:
at least one characteristic measure of a first type, wherein a characteristic measure of the first type is a measure based on a comparison of a distribution of a said at least one drilling variable for the drill hole with a distribution of a related or the same drilling variable across a plurality of the drilled holes; and
at least one characteristic measure of a second type, wherein a characteristic measure of the second type is based on said at least one drilling variable across the plurality of depths of the drilled holes;
applying, by the one or more computing systems, unsupervised learning to the plurality of characteristic measures, the unsupervised learning determining groups of the drilled holes; and
generating, by the one or more computing systems, an output indicating the determined groups of the drilled holes; and
assigning at least one depth of the drill hole or the drill hole to a group of the model determined by the unsupervised learning.

22. The method of claim 21, wherein the model indicates a plurality of groups and each group indicates at least one physical characteristic of rock.

23. The method of claim 21, wherein the at least one physical characteristic of rock comprises rock hardness.

24. The method of claim 22, wherein assigning the drill hole to the group of the model determined by the unsupervised learning comprises:
assigning, by the one or more computing systems, each depth of the drill hole to one of the groups of the model;
determining, by the one or more computing systems, a group of the model that corresponds to the majority of the depths of the drill hole; and
assigning, by the one or more computing systems, the determined group that corresponds to the majority of the depths of the drill hole to the drill hole.

25. The method of claim 21, further comprising adding the at least one depth of the drill hole or the drill hole to the group of the model determined from the unsupervised learning.

26. (canceled)

27. Non-transient computer storage comprising instructions that, when executed by a computing system, cause the computing system to perform a method comprising:
receiving or generating, at one or more computing systems, data comprising at least one drilling variable for a plurality of drilled holes across observations at a plurality of depths, wherein the at least one drilling variable is a variable affected by at least one physical characteristic of rock in the plurality of drilled holes;
determining, by the one or more computing systems, a plurality of characteristic measures for each of the plurality of drilled holes, wherein the plurality of characteristic measures for each drilled hole comprise:
at least one characteristic measure of a first type, wherein a characteristic measure of the first type is a measure based on a comparison of a distribution of a said at least one drilling variable for the drill hole with a distribution of a related or the same drilling variable across a plurality of the drilled holes; and
at least one characteristic measure of a second type, wherein a characteristic measure of the second type is based on said at least one drilling variable across the plurality of depths of the drilled holes;
applying, by the one or more computing systems, unsupervised learning to the plurality of characteristic measures, the unsupervised learning determining groups of the drilled holes; and
generating, by the one or more computing systems, an output indicating the determined groups of the drilled holes.
